(19) United States
(12) Patent Application Publication
(10) Pub. No.: US 2008/0162692 A1
(43) Pub. Date: Jul. 3, 2008

(54) SYSTEM AND METHOD FOR IDENTIFYING AND BLOCKING SEXUAL PREDATOR ACTIVITY ON THE INTERNET

(75) Inventors: Martin Schultz, Miami Beach, FL (US); David Spector, Delray Beach, FL (US)

Correspondence Address: Edwards Angell Palmer & Dodge LLP, P.O. Box 55874, Boston, MA, 02205, US

(73) Assignee: PARENTS ON PATROL, INC., Miami Beach, FL (US)

(21) Appl. No.: 11/968,986

(22) Filed: Jan. 3, 2008

Related U.S. Application Data
(60) Provisional application No. 60/878,279, filed on Jan. 3, 2007.

(51) Int. Cl. G06F 15/173

(52) U.S. Cl. 709/224

(57) ABSTRACT

A method for preventing undesired communication with a target computer across a distributed network. At least one rule regarding electronic communication is stored. Electronic communications are monitored at a server. The server applies at least one rule to the electronic communication. The server controls the electronic communications with the target computer and the source of the electronic communications as a function of the rule.

### CROSS-REFERENCE TO RELATED APPLICATIONS

This application is a Non-provisional of Provisional (35 U.S.C. 119(e)) application No. 60/878,279 entitled SYSTEM AND METHOD FOR IDENTIFYING AND BLOCKING SEXUAL PREDATOR ACTIVITY ON THE INTERNET, filed Jan. 3, 2007.

### BACKGROUND OF THE INVENTION

This application is directed to software which may be loaded on a target computer for blocking communications with the target computer from undesired remote computers, and in particular, software for preventing undesired electronic communication with a child's computer over distributed networks such as the Internet.

With the ease of digital communication provided by the Internet and the world wide web it is now possible to communicate with and send information to any computer located anywhere in the world. However, if desired, the source of the information or communication may remain anonymous either behind a deceiving or misleading domain name or a fanciful e-mail address or be password protected. All sorts of criminals make use of the anonymity of the Internet to prey on the innocent; utilizing such known techniques as “phishing,” and more egregiously, sexual predator activities directed at children. This activity may also take place on community websites. Sexual predator activity is of real concern because children have not developed the necessary tools of interacting with society to determine the difference between legitimate flirtatious e-mail traffic and that of a sexual predator.

Furthermore, with the growth of the Internet, such sexual predator behavior has grown at a rate and to a size that makes it almost impossible for conventional law enforcement to effectively prevent predator traffic. Therefore, there is no method other than word of mouth and educating children of predator behavior patterns to help children and parents regarding these unwanted predators. Accordingly, it is desired to provide a system and method for automating information screening to detect, report and prevent such predator behavior.

### BRIEF SUMMARY OF THE INVENTION

A target computer having access to the Internet is provided with a software product for detecting and recording electronic communications. The electronic communications are stored remotely behind a password protected database. A control computer, also having access to the Internet and the database, may access the database to monitor electronic communications which occurred at the target computer. The control computer may initiate rules to be applied by a central computer with respect to the detected communications at the target computer; the rules flagging and preventing unwanted electronic communications at the target computer.

In a preferred embodiment, the target computer is a child's computer which provides the child access to the Internet. The control computer is any computer accessible to a parent, guardian or responsible individual (collectively “parent”) of the child and also capable of communicating across the Internet. In a preferred embodiment, the central computer upon detection of a communication which violates the rules, prevents further transmittal of any communication from any identified communication source to the child's computer. In a further embodiment, the control computer may also alert a third party such as law enforcement or a communal parent repository, accessible by third parties, of e-mail addresses corresponding to prohibited communications. In yet another embodiment, use of websites by the child may be monitored along with any necessary user names and passwords.

### BRIEF DESCRIPTION OF THE DRAWINGS

FIG. 1 is a schematic drawing of a system for implementation of the invention across the distributed network;

FIG. 2 is a flow chart for initializing the system in accordance with the invention;

FIG. 3 is a flow chart of a method for a control computer to monitor activity at the target computer in accordance with the invention;

FIG. 4 is a flow chart of a method for setting and applying new rules in accordance with the invention;

FIG. 5 is a flow chart for the method of notifying other parents or third parties of the existence of an undesirable e-mail source in accordance with the invention;

FIG. 6 is a flow chart for the method of notifying the control computer of the detection of an undesired electronic communication in accordance with the invention;

FIG. 7 is a flow chart for a method for notifying other interested third parties such as law enforcement in accordance with the invention;

FIG. 8 is a flow chart for a method for preventing mistaken identification of predators to the public at large in accordance with the invention; and

FIG. 9 is a flow chart for a method of monitoring website use.

### DETAILED DESCRIPTION OF THE INVENTION

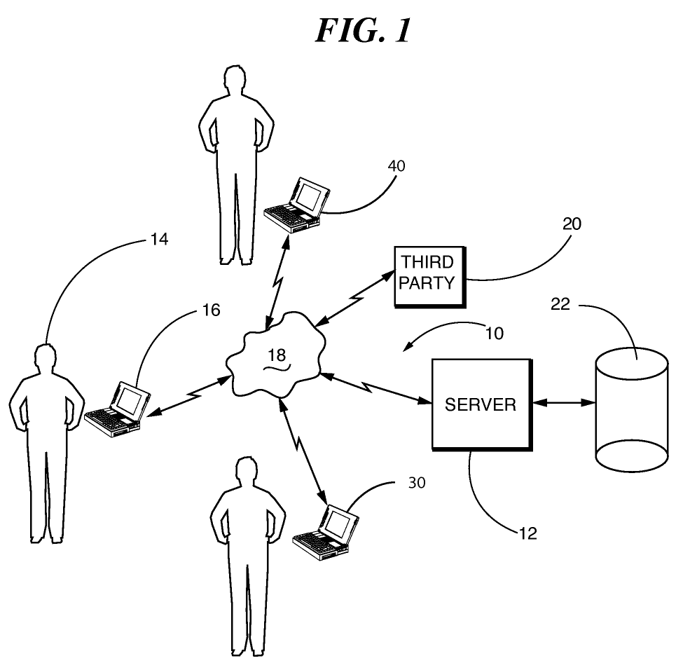

Reference is first made to FIG. 1 in which a distributed network, preferably the Internet, across which the invention is provided is shown as system 10. System 10 includes a server 12, which operatively communicates with a database 22, which is the repository for the information and data to be discussed below and, which is operated upon by server 12. Server 12 communicates across a distributed network 18 (the Internet) to a target computer 30, a control computer 40, as well as to a computer 16 corresponding to an undesired individual or data source 14. It should be noted that each of computers 16, 30, 40 are interactive devices which allow an individual associated with the respective computer to communicate (bidirectional messaging) with server 12. It should also be noted, that the preferred embodiment is an Internet-based system. However, the system may include any computing device capable of detecting, monitoring and/or recording all or portions (each segment) of an electronic bidirectional communication directed to or produced from the computing device. The computing device is any device capable of performing electronic communication across Internet 18 or other communication network and may include a telephone, a pager, an RF receiver or a personal digital assistant by way of non-limiting examples.

Database 22 is a repository for information which is developed over time in accordance with the invention. At the outset, a parent or other person associated with control computer 40 develops rules for communication by any source with target computer 30. These rules are stored in database 22 and are operated upon by server 12. By way of non-limiting example, these rules which govern the use of target computer 30 may determine objectionable language, a window during which computer 30 may be used based on time and day of week, an overall amount of use during a predetermined period such as no more than three hours during one 24-hour period, which addresses may be visited by a user of computer 30, which instant messaging aliases or even which e-mail addresses are permitted to communicate with computer 30.

In addition to rules for determining use, rules may be stored for actions to be taken by server 12 at target computer 30 when rules are violated. Accordingly, instructions such as terminating a conversation, allowing the conversation but notifying control computer 40 of the occurrence of the conversation, or just recording the conversation and storing it in database 22 in an events repository are stored in database 22. These actions can be applied both when an incoming conversation segment which violates a rule is detected as well as an attempt by target computer 30 to violate a rule by contacting either a prohibited instant message aliases, domain name, e-mail address, or during prohibited operating hours.

For operation of the rules, there are other repositories stored in database 22 corresponding to lists of sexual predators or other undesirable parties for which communication is to be either very closely monitored in accordance with the rules or prevented in its entirety. This repository would include electronic alias (instant message party alias) of the prohibited sender along with some profile information about the sender such as the type of preferred messaging whether it be chat room, direct e-mail, instant messaging, short messaging for telephone, pager or the like. The date and time when this party was first recognized as an undesirable instant message alias or e-mail address or the number of times that this particular address has been reported by the user of a control computer 40 may also be stored as well as the geographical location of the parents corresponding to either the control computer 40 or target computer 30 to which e-mail from this undesired source has been forwarded.

There is also an incident repository stored in database 22. This repository will contain the electronic conversation that caused a parent or other user of control computer 40 to determine that the e-mail address or instant messaging alias corresponding to the message was an undesirable instant message alias or e-mail address. This repository may also include the time and date of the initial conversation or communication that convinced the user of control computer 40 that the information source should be barred as well as any other relevant information about the communication such as key words, length of conversation or the like which will help develop a profile of user 14.

There is also a parent repository stored in database 22. The parent repository contains information about the parents or other users of control computer 40 who make use of system 10. This information may include demographic information about the parent including name, address, zip code, county, state of the parent, control computer 40 and target computer 30. The parent repository also includes the identity of the parent or user of control computer 40 and the pass code to allow access to server 12 and the associated portion of database 22 corresponding to target computer 30 and control computer 40 for that particular parent.

The preferences and details of the parent such as how they wish to be notified of any violations of the rules stored in the rule repository are also stored in database 22. This may include information such as whether notification occurs by e-mail, text messaging, instant messaging, or a short message at a cell phone.

Database 22 may also include a conversation repository that contains the contents of that entire conversation which is monitored and recorded in accordance with the invention. The recorded portions (each segment originating with the respective users) of the conversation would be stored at database 22 in the conversation repository. Furthermore, identification about the conversation would also be included such as the date, time and instant message alias or e-mail addresses utilized by the participants. The conversation monitored may be one-to-one for instant message or e-mail conversations, may be one-to-many such as a blog situation, or may be many-to-many such as a chat room in which many e-mail addresses would be associated and stored with the conversation in database 22. Server 12 may also monitor each segment for banned language.

There may also be an event repository where events of interest such as those that break the stored rules would be stored. We note that the event repository may in fact include the same information as, or point to portions of, the conversation repository. The event repository stores trigger events by storing the type of event (which rule is violated), the date and time of such trigger, the associated parent in the parent repository and the associated conversation in the conversation repository. These events may include violations of attempted conversations with prohibited e-mail addresses or instant messaging aliases, use of inappropriate language or activities during a conversation, excessive usage of electronic communication rules or a visit to a prohibited chat room.

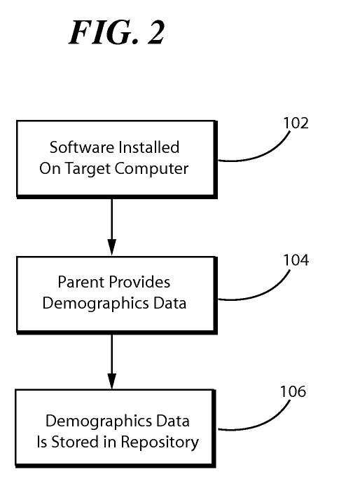

Reference is now made to FIG. 2 to better describe how the invention is implemented across the novel system.

First, the system must be initialized. In a first step 102, the parent or guardian associated with control computer 40 installs software on target computer 30. This software monitors electronic communication in accordance with the invention. The software monitors keystrokes at target computer 30, images and sounds displayed at target computer 30, and incoming electronic communication streams at target computer 30. The software is capable of searching for identifying key words, images, instant message identities, e-mail addresses and domain names and recording the conversation and associated information as discussed above in connection with the repositories for any electronic conversation occurring at computer 30. The software sends each monitored conversation (in real time) to server 12 for operation of the rules.

In a step 104, the parent utilizes the software to store parent demographic information such as name, physical location of both control computer 40 and any target computer 30 as well as the password for accessing database 22. In a step 106, the software causes this information to be stored in the parent repository of database 22.

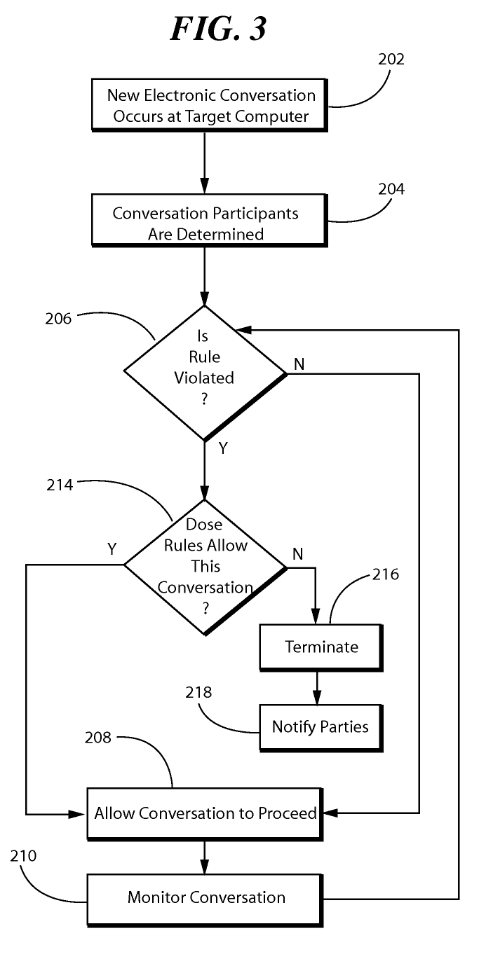

Reference is now made to FIG. 3 in which operation of the system for preventing unwanted electronic communications is described.

In a step 202, a new electronic conversation such as, an instant message, occurs at the child's computing device 30. The software loaded at computing device 30 identifies the participants of the conversation by URL, domain name, instant message alias or e-mail address (collectively, “addresses”) in a step 204. This information is transmitted to server 12. Server 12, utilizing the repositories in database 22 then determines whether or not any of the addresses participating in the conversation are a prohibited address as stored in the repositories in a step 206 or whether any other rules are violated. As part of this process, server 12 determines in a step 208 whether or not the rules stored in database 22 allow conversations with this particular address or for this violation to continue. If the address is not on the prohibited list, or no rule is violated, then the conversation is allowed to proceed in a step 208 and further monitoring of the conversation occurs in a step 210 and the process is returned to step 206 to determine whether further rules are violated.

If in fact a rule is violated as determined in step 206, then it is determined whether or not the rules allow continued conversation for the violation. If in fact it is, then the conversation is allowed to proceed in step 208.

If in fact a rule is violated and the conversation is not allowed to proceed, then server 12 terminates the conversation in a step 216 in accordance with known communication blocking technologies, such as firewalls (closing the TCP/IP port), terminating the program, sending a windows message to the appropriate component of the system or close the instant messaging window. In an optional step, the demographic information of the type discussed above in connection with the repositories associated with this conversation is then sent to server 12 for storage in the appropriate repositories in database 22 in accordance with a step 218. It should be noted that even if the conversation is allowed to continue in accordance with step 214, as discussed above in connection the rules repository, although the conversation is allowed to proceed in a step 208, action may be taken such as to monitor or continue to monitor and record the conversation or even to notify appropriate third parties 20 such as the police, other parents or to notify the parent associated with the child at computer 30. The conversation content itself may be stored in a repository of database 22 mapped to its demographic data, including time of occurrence or even use of banned or key words.

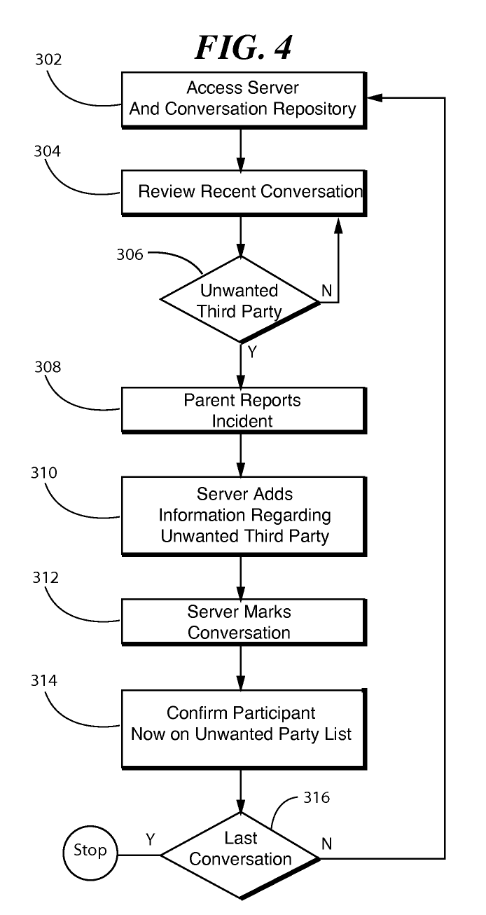

Reference is now made to FIG. 4 in which a flow chart for dynamically modifying the rules by parent intervention is provided. In a step 302, the parent at control computer 40 inputs their secret password to access server 12 and the conversation repository stored in database 22 corresponding to conversations monitored at target computer 30. In a step 304, the parent reviews all conversations conducted at target computer 30 since the last review. In a step 306, the parent determines on a conversation-by-conversation basis whether the conversation involved what appears to be with an unwanted party.

If the conversation is permissible, the process returns to step 304 and other conversations are reviewed. If a conversation appears to be with an unwanted party, then in a step 308 the parent causes server 12 to transmit information regarding the unwanted party to third party sites 20 at which they may be aggregated as a warning to others or used for follow-up investigation by law enforcement.

To prevent abuse, the information which would lead a parent to believe that the conversation is unwanted or unwarranted would also be forwarded.

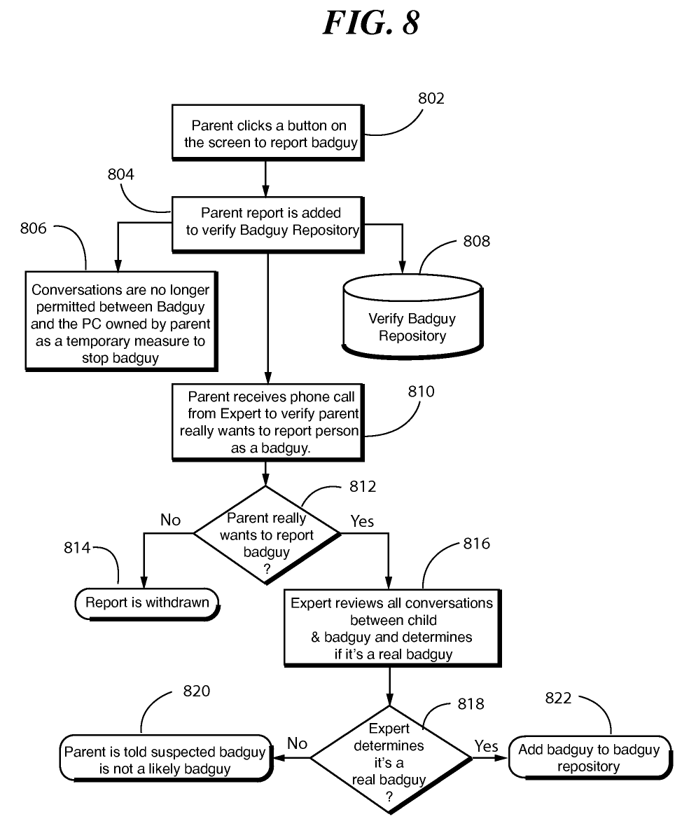

In accordance with one preferred, exemplary but non-limiting embodiment, as seen in FIG. 8, the parent utilizes a graphical user interface “GUI” at control computer 40 and selects an icon by “clicking” a button on the screen to report an unwanted source of information (“bad guy”). The parent report is added to a verified bad guy repository in a step 804. As an intermediate step 806, conversations are no longer permitted between the alias or e-mail address of the bad guy and computer 30 while the parent report is added to the verified bad guy repository in steps 804, 808. In effect, a new rule has been written and stored in the rule repository.

To ensure that only true predators 14 are blocked from conversation, in the step 810 a parent will be contacted by an expert to verify the parent actually wishes to report this predator 14 as a bad guy in a step 810. This is an initial vetting process in which the expert will lead the parent through a process for differentiating true predators from merely flirtatious normal behavior.

If it is determined in step 812 that the parent in hindsight does not wish to add this address to the bad guy repository then the report is withdrawn and the name is withdrawn from the appropriate repositories in a step 814. However, if the parent persists in taking action, then the expert will review the conversations between the child and the potential predator 14 to determine whether predator 14 is in fact a predator. If the expert determines in a step 818 that in fact predator 14 is a predator and should be barred from further conversations with children, the bad guy is added to the repository of unwanted information sources in step 822. On the other hand, if the expert determines that in fact, based upon their review of the conversation history at computer 30, that predator 14 is in fact, not a true predator, then the parents are told that the suspected bad guy is not a likely bad guy in step 820. It should be noted, that as a result of step 820 the parent may continue to prohibit conversations with user 14 as part of their own personal rules, but user 14 will not be identified as a predator to third parties. The process then returns to step 304 for further review of other conversations.

In a step 310, the server 12 adds the conversation information to the unwanted or prevented address repository of database 22. Server 12 marks the conversation, date and time stamps the conversation along with the parents' demographic information and location, all mapped to the information regarding the source of the unwanted conversation and stores this information in the conversation and event repositories in a step 312. In a step 314, server 12 confirms to the parent at control computer 40 that this conversation and the participant is now on the undesirable address list and all future electronic conversations will be processed in accordance with the rules set up by the parent. The process then returns to step 307 until all new conversations have been reviewed.

It should be noted that in this embodiment, central server 12 reported the occurrence to third party 20 while also developing the necessary repositories in database 22. It should also be noted that it is well within the scope of the invention to perform either step 308 or step 310 without necessarily performing the other, to perform them simultaneously or in reverse to the order shown in FIG. 3.

Server 12 has access to each of the repositories including the conversation repository as well as the address or alias repository and can map each conversation to an instant messaging alias, e-mail address, domain name or blog of a predator 14. It is simple enough for predator 14 to change its alias from conversation to conversation and amongst different target individuals at the various target computers 30 to escape detection and to prevent developing a pattern which children may recognize. However, the conversations most often have a commonality of phrases, themes and the like. By way of example, some time during the relationship, predator 14 pretending to be a teenager may suggest that a target child “check him out” at a profile repository such as “MySpace.com”, “YouTube” or the like. When a parent reports a potential predator 14 as discussed above in connection with FIG. 8 to server 12, server 12, may then pay particular attention to the conversations with potential predator 14 and search for key words such as “check my profile”. Server 12 will also monitor the profile address and name. It may then compare that profile name to the use of such a profile name in the conversation repository for all conversations. Each time a reference to the same profile key words is found in the conversation it is determined that this is the same person operating under different aliases. The parent associated with each conversation involving predator 14 is notified that their child may have been talking with a suspected predator. The parent may be shown the conversation itself to make their own determination. Although it is easy to use a plurality of electronic aliases to contact target computer 30, it is not as easy to create a number of online profiles under different names. Therefore, by mining the data of the conversations using pattern recognition algorithms, and mapping it to the different aliases, server 12 is able to uncover predator 14, even though predator 14 has attempted to hide behind other aliases.

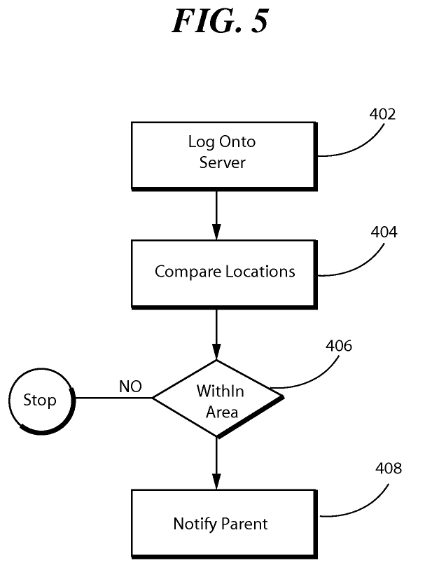

Reference is now made to FIG. 5 in which a methodology for notifying parents of other children of the occurrence of an unwanted conversation is provided. In this way, other parents may be warned automatically by server 12 of a predator who may be contacting their children.

Once an unwanted address has been identified, server 12 can determine whether or not the address or Internet identity has already been indicated in a repository of another parent to be an unwanted electronic communication with their child. Server 12 can then just warn other parents of a repeat offender, relying on the collective wisdom of the population of users once a certain critical mass has been reached and it can be determined that it is more likely than not that this information source is an unwanted predator. Furthermore, server 12 can determine the demographic data associated with parents who have identified user 14 as an unwanted source of electronic communication to determine if there is a pattern. Therefore, if there is a commonality geographically of target computers 30 or control computers 40 it can be determined based on empirical evidence that it is more likely than not that stalker 14 and computer 16 are located in the general vicinity of the plurality of control computers 40 making reports to server 12.

Accordingly, in accordance with another embodiment of the invention in a step 402, a parent using their password and user name signs into server 12 from control computer 40. The demographic data of the users of control computer 40 is compared to a predicted location of the unwanted user 14 in a step 404. If it is determined that in fact a stalker 14 is within a predetermined limited geographic area with control computer 40, server 12 will send a warning to control computer 40 that there are potential stalkers within the predetermined distance to their computer in a step 408. If a stalker 14 is outside the predetermined area, no warning will be sent.

It should be noted that in the contemplated embodiment, server 12 may e-mail such a warning to all of the registered control computers 40 on system 10 within the predetermined area.

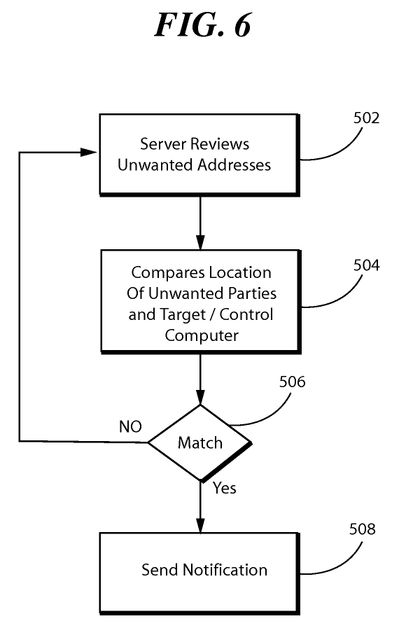

Reference is now made to FIG. 6 in which a method for automatically reporting the presence of a stalker 14 within a predetermined geographic area is provided. In a step 502, server 12 scans the repository of known unwanted addresses and the known location of the known unwanted addresses in the physical world (or the predicted location, based upon the addresses of the target computer 30 to which the stalker 14 has communicated).

In a step 504, the determined location is compared by server 12 to the geographical location of each and every parent associated with a control computer 40. It is then determined whether there is a match between addresses in a step 506. In other words, server 12 searches where the address of control computer 40 is less than a predetermined distance from the determined location of stalker computer 16. If there is no match, then the process is returned to step 502. If there is a match as determined in step 506, then the parent is sent an electronic notification that they are within the known geographical area from the predator 14 utilizing stalker computer 16 in a step 508. Such a scan is performed on a periodic basis and may occur hourly, daily, weekly or at greater or lesser intervals.

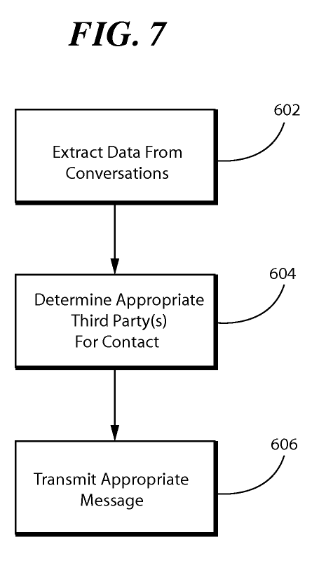

Reference is now made to FIG. 7. As discussed above, in accordance with a step 308 of the general process, a report of unwanted behavior may be sent to third parties 20 such as law enforcement. In a step 602, server 12 extracts instant messaging conversation occurring at target computer 30 as discussed above. It will extract conversations, demographic information and participant information for each new unwanted conversation either as a function of violated rules stored in database 22 or as indicated by parents as discussed above. Each new unwanted information source or each new incident from an existing unwanted information source will be added to the repository. Server 12 may use the collective incidents to create profiles regarding predator 14.

Applying rules in a step 604, server 12 will determine which third party, including the appropriate law enforcement agency, to which transmission regarding newly identified unwanted information sources or new incidents involving known unwanted information sources should be transmitted. The information may be transmitted as a function of the locale of either target computer 30 or computer 16 as well as the current laws in that jurisdiction. In a step 606, central server 12 electronically transmits the information and marks the repository to indicate that the information was transmitted.

By enabling server 12 to monitor conversations occurring on a plurality of target computers 30, a method for automatically identifying potential predators without the need for constantly, physically monitoring the behavior of a child is provided. Additionally, by monitoring the process, a more accurate profile of predatory activity is provided. Furthermore, the description above was conducted with a simple universe of one predator 14, one target computer 30 and one control computer 40 for simplification and to facilitate description. However, it is well understood that the system and processes can be utilized across a distributed network taking advantage of a network of servers 12 or a single server 12 and a network of target computers 30. As a result, server 12 can use the collective wisdom and monitoring of the entire community to better determine the activities of undesirable and unwanted users 14 such as child predators.

Predatory behavior can also occur behind web pages such as in chat rooms, in community websites and the like. Often, instant messaging leads to a referral to a face book or a community page, which the predator uses to lure unsuspecting children. Therefore, parents may also wish to capture the user names and passwords of websites such as web-based e-mail systems, web-based social networks, web-based games and the like that their children use when the child is browsing the Internet. In this embodiment, rather than a personal computer, third party computer 20 may actually represent a third party website hosted at a server having undesirable or inappropriate pages for children. In accordance with one embodiment of the invention, server 12 monitors the activity of target computer 30 at an Internet site represented by third party 20. This activity, as will be discussed in detail below, is also stored in a repository in database 22 much in the same way as other information was stored as discussed above.

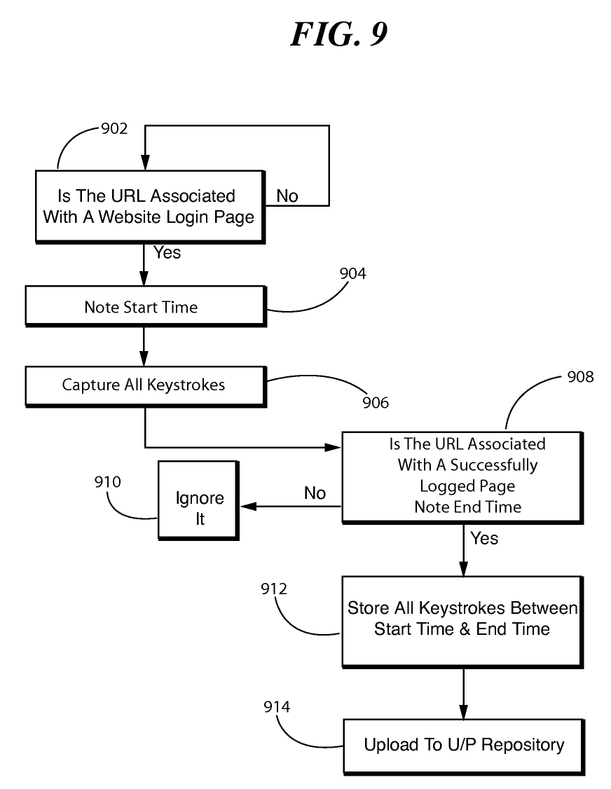

Referring now to FIG. 9 in which a method in accordance with another embodiment of the invention for monitoring web page activity is provided. As discussed above, server 12 monitors activity at target computer 30. This may be either keystroke activity, TCP/IP traffic, visual display activity, outgoing or received text activity or the like. By searching for a uniform resource locator (URL) trigger such as “.com”, “net”, “.biz” or the like or other indicators of the use of a URL, server 12 determines that a website is being visited by target computer 30. As an initial step, server 12 may be populated with known sites not appropriate for children such as pornographic sites, other adult content type-sites, or even the communal pages of known predators as determined utilizing the methodologies discussed above and below. These web address are stored in database 22 in a web address depository.

To monitor web page content, a parent needs the child's name and password. To obtain this information, it is first determined in a step 902 whether a currently accessed URL is associated with a website login page. If yes, server 12 notes a START time in step 904 and begins capturing all keystrokes in a step 906. A START time for the web access is stored along with the identification of the page such as the identity of the email system or social network. If the website page is not a login page, step 902 is repeated until a login page is found.

Once a child successfully logs into enters a web site, a new page populates computer 30. If it is determined in step 902 that the URL is no longer associated with a login page, it is determined whether the page corresponds to successful login in a step 908. If the URL is associated with a successfully logged in page, then an END time is noted. All keystrokes between the START time and the END time are determined in a step 912. These keystrokes captured between the START time and the END time are, by default, the user name and password needed to access the website. The captured keystrokes are stored in a user name/password repository in database 22 in step 914. A parent utilizing control computer 40 as discussed above gains access to the repository in database 22 and may utilize the password and user name to check the non-public websites and web pages visited by the child.

The URL is stored with the password and user name in database 22. As discussed above, rules input at control computer 40 can be set up for blocking access to recognized URLs utilizing known website blocking techniques such as those provided by CYBERNANNY or the like.

In one non-limiting, exemplary embodiment, the system determines whether a suspect page, and/or login page for a suspect website and successful login has occurred by storing a URL corresponding to the suspect website login and success pages in a depository of database 22. Mapped to the URL is the page-specific address of the login page and the successful login page for the suspect website. Server 12 compares the displayed page at target computer 30 to saved logged in pages at communal websites such as MYSPACE, FACEBOOK, or the like and compares the stored URL information with that displayed at target computer 30. When there is a match, server 12 saves the user name and password as discussed above.

Furthermore, by monitoring the process, more accurate profile of predatory activity is provided. Lastly, it should be understood that although the preferred embodiment involves monitoring instant messages in real time, the process can be applied to e-mail conversations, chat rooms, blogs, and websites.

Thus, while there have been shown, described and pointed out novel features of the present invention as applied to preferred embodiments thereof, it will be understood that various omissions and substitutions and change in the form and detail are contemplated so that the disclosed invention may be made by those skilled in the art without departing from the spirit and scope of the invention. It is the intention therefore to be limited only as indicated by the scope of the claims appended hereto. It is also to be understood that the following claims are intended to cover all of the generic and specific features of the invention herein described and all statements of the scope of invention, which as a matter of language, might be said to fall therebetween.

What is claimed as new and desired to be protected by Letters Patent of the United States is:

1. A method for preventing undesired communication with a target computer across a distributed network comprising the steps of:
storing at least one rule regarding electronic communications forming bidirectional electronic communications with the target computer;
monitoring each of said electronic communications forming bidirectional electronic communications with said target computer at a server, the server applying said at least one rule to said electronic communication; and
the server controlling the bidirectional electronic communications between said target computer and a source of said electronic communications as a function of the rule.

2. The method of claim 1, further comprising the steps of:
monitoring and storing each electronic communication occurring at the target computer;
reviewing each communication across the distributed network from a control computer and updating the at least one rule as a function of the monitored communication.

3. The method of claim 1, further comprising the steps of:
monitoring and recording each electronic communication occurring at the target computer and identifying a source of the electronic communication; and
storing the identity of that source.

4. The method of claim 3, further comprising reporting the identity of the source to a third party in accordance with said at least one rule.

5. The method of claim 1, wherein the target computer is a computer used by a child.

6. The method of claim 4, wherein said third party is a law enforcement agency.

7. The method of claim 1, wherein said at least one rule is one of limiting the hours during which electronic conversations may be received; limiting the overall time during which electronic conversations may occur within a predetermined period; preventing conversations with a predetermined e-mail address or domain name.

8. The method of claim 1, wherein said control computer causes the source information to be sent to a third party across the distributed network.

9. The method of claim 3, further comprising the steps of identifying the source as a predator and storing the fact that the source corresponds to a predator; searching the electronic communication originating from the predator for key words which identify a pattern associated with the predator; and searching each stored communication for the key words; and identifying any alias of each source associated with each communication containing the key word.

10. The method of claim 3, further comprising the step of confirming by an expert that the source corresponds to a predator prior to storing the identity of that source as a known predator.

11. A system for preventing undesired communication with a target computer across a distributed network comprising:
a target computer;
a server, the server and target computer communicating with each other across a distributed network, the server storing at least one rule regarding bidirectional electronic communication with the target computer, monitoring each electronic communication forming bidirectional electronic communication with the target computer and applying the at least one rule to the electronic communication and then controlling the bidirectional electronic communication between the target computer and a source of electronic communication as a function of the rule.

12. The system of claim 11, further comprising a control computer in communication with the server, the control computer reviewing each communication of the bidirectional electronic communication received at the target computer and modifying the at least one rule as a function of the monitored communication.

13. The system of claim 11, wherein the server monitors keystroke activity of the target computer, determines whether a web page associated with a website login is being accessed, captures and notes a start time, captures all keystrokes beginning at a start time; determines whether a second URL is accessed at the target computer and whether the second URL is associated with a successful login page and notes an end time; and stores all keystrokes between the start time and end time.

14. A method for monitoring and preventing undesired communication with a target computer across a distributed network comprising the steps of:
monitoring a target computer across a distributed network;
monitoring electronic communications between said target computer and a third party server, the server hosting a website;
determining whether a website page associated with a website login is being accessed and determining a START time if the web page is a login page;
determining whether a second web page associated with a successful login is accessed and determining an END time when the target computer accesses a second page associated with a successful login page; and
capturing all keystrokes at the target computer between said START time and said END time.

15. The method of claim 14, further comprising the step of storing all the captured keystrokes as a user name and password; and
storing the uniform resource locator associated with the website login page in said repository.

16. The method of claim 15 further comprising the steps of storing at least one rule regarding the uniform resource locator in the database; and
the server applying at least one rule to control communication between said target computer and said server hosting said web page to control access to said website.
